(19) United States
(12) Patent Application Publication
(10) Pub. No.: US 2020/0036048 A1
(43) Pub. Date: Jan. 30, 2020

(54) DUAL BATTERY SYSTEM FOR CELL PHONE

(71) Applicant: Michael Donnell Adams, JR., Chicago, IL (US)

(72) Inventor: Michael Donnell Adams, JR., Chicago, IL (US)

(21) Appl. No.: 16/188,572

(22) Filed: Nov. 13, 2018

Related U.S. Application Data
(60) Provisional application No. 62/703,609, filed on Jul. 26, 2018.

(51) Int. Cl. H01M 10/42; H02J 7/00; H04B 1/3883; H01M 10/48

(52) U.S. Cl. CPC H01M 10/425; H02J 7/0021; H01M 2010/4271; H01M 10/488; H01M 2220/30; H04B 1/3883

(57) ABSTRACT

A user selectable dual battery system for a mobile communications device. The system has a user selectable switch to select between one of two batteries in the dual battery system. When one of the batteries goes dead with just a quick switch you use the other one for emergency. The dual battery provides the user with an extra reserve of battery power so they don't have to worry if their phone goes dead.

### CROSS-REFERENCE TO RELATED APPLICATION

This application claims the benefit of priority of U.S. provisional application No. 62/703,609, filed Jul. 26, 2018, the contents of which are herein incorporated by reference.

### BACKGROUND OF THE INVENTION

The present invention relates to portable electronic devices, such as cellular phones, and more particularly to battery power supplies for the same.

Power management for portable electronic devices is a recurring problem. In many instances, particularly for cellular telephone devices, battery depletion may occur prematurely when the device has to boost its power consumption in order to maintain connectivity or search for available signal communications towers in a cellular telephone network. Because this is typically an automated procedure for the device, the user may not be aware of the depletion until they receive a low battery warning. If the user is carrying the device in a carrier, such as a pocket or a purse, the device may deplete to a critical level before the user is even aware of the condition. This leaves the user with limited communications capability in the event of an emergency.

In most instances, if a battery supply completely discharges, the device will require connection to a charging power supply before it may be placed in an operational mode.

As can be seen, there is a need for an improved battery supply system for portable electronic devices, particularly cellular communications devices.

### SUMMARY OF THE INVENTION

In one aspect of the present invention, a battery system for a portable electronic device is disclosed. The battery system includes a housing for a portable electronic device having interior cavity to contain electronic circuitry for the portable electronic device. A first battery and a second battery are contained within the housing to power the electronic circuitry. A battery selector switch, operable from the exterior of the housing is provided. The battery selector switch is selectable between a first position and a second position, such that when in the first position, the first battery powers the electronic circuitry, and when in the second position, the second battery powers the electronic circuitry.

The battery system may be configured such that in the first position, the second battery does not power the electronic circuitry and in the second position, the first battery does not power the electronic circuitry.

In some embodiments, the battery system includes indicia proximal to the selector switch indicating a selection of one of the first battery or the second battery.

In embodiments with an electronic display visible on at least one surface of the portable electronic device, a charge state circuit determines a charge state of the first battery and the second battery. A first visual indicator may be provided indicating a charge state of the first battery. Likewise, a second visual indicator indicating a charge state of the second battery. A least one of the first visual indicator and the second visual indicator may be shown on the electronic display. The first visual indicator and the second visual indicator may include a graphical indication of the charge state and a textual representation of the charge state. In some embodiments, a battery selection indicator is displayed proximal to one of the first visual indicator and the second visual indicator to provide a visual indication of the battery selected by the battery selector switch.

In some embodiments, the charge state circuitry is configured to power down the portable electronic device when the charge state circuitry detects a near depleted condition of the selected battery.

Preferably, at least one of the first battery and the second battery is a rechargeable battery. In this instance, a charging circuit is configured to charge the rechargeable battery. The charging circuit may be coupled to the charge state circuit and is configured to charge one of a depleted or partially depleted rechargeable battery.

These and other features, aspects and advantages of the present invention will become better understood with reference to the following drawings, description and claims.

### BRIEF DESCRIPTION OF THE DRAWINGS

FIG. 1 is a schematic view of a dual battery system for a mobile communications device with both batteries charged and the switch in the right position.

FIG. 2 is schematic view of the dual battery system for a mobile communications device, illustrating the switching of batteries when one is discharged.

FIG. 3 is a schematic view of the dual battery system for a mobile communications device with a selector switch in the left position.

FIG. 4 is a flow chart of the dual battery system for a mobile communications device.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention The following detailed description is of the best currently contemplated modes of carrying out exemplary embodiments of the invention. The description is not to be taken in a limiting sense, but is made merely for the purpose of illustrating the general principles of the invention.

Broadly, embodiments of the present invention provides a user selectable dual battery capability for a portable electronic device, such as a cellular telephone, smart phone, tablet, or the like.

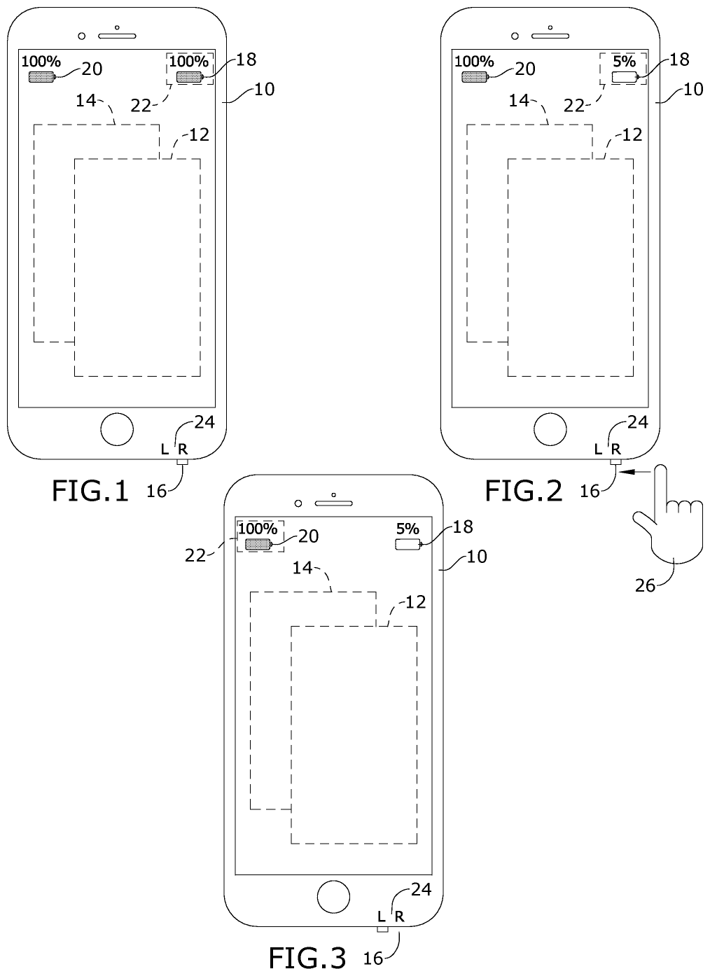

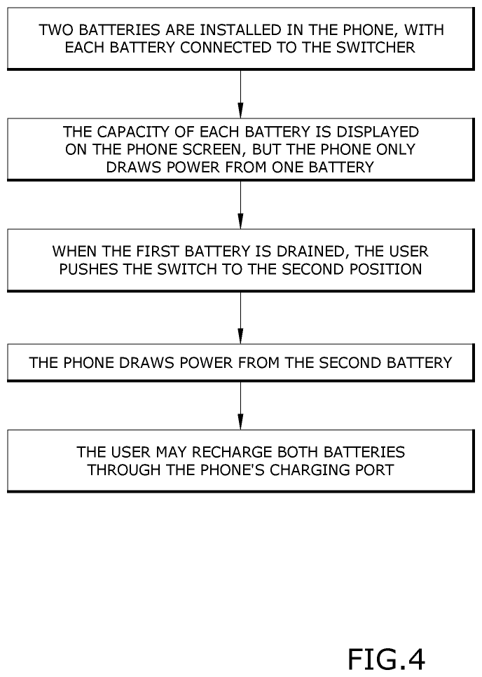

A dual battery system for a mobile communications device may be seen in reference to FIGS. 1-3. The system includes a portable electronic device 10, such as a cell phone. The device includes a first battery 12 and a second battery 14 carried within a body of the portable electronic device. A battery selector switch 16 is provided to enable the user 26 to select one of the first battery 12 or the second battery 14 to power the device 10. The case of the portable electronic device 10 may also include indicia 24 designating a selected battery of the battery selector switch 16.

As seen in reference to FIG. 1, a display of the device 10 may include a first visual indicator 18 depicting the charge state for the first battery 12 and a second visual indicator 20 depicting the charge state of the second battery 14. In this case, each of the first visual indicator 18 and the second visual indicator 20 show that their respective battery 12, 14 is charged to a full charge. The visual indicators 18, 20 may include a graphical indication of the charge state and a textual representation, such as a % of charge capacity.

As seen in reference to FIGS. 2 and 3, the first charge indicator 18 indicates a partially depleted condition, while the second charge indicator 20 indicates a full condition. A battery selection indicator 22, such as a bounding box, highlight, or other graphical indication, provides a visual indication of the battery 12, 14 that is selected by the battery selector switch 16.

In use, the user 26 would select a desired battery 12, 14 for operation of the device 10, which would operate according to its normal operational parameters. Should the selected battery 12, 14 become depleted, the user may simply operate the switch 16 to select the other battery as a backup or standby power source. In operation the device display would provide a visual indication of the charge condition of each battery. In some embodiments, the display would also include a battery selection indicator 22 to show which battery the user 26 has selected for operation of the device 10.

In the event that one of the first 12 or second 14 battery becomes fully depleted, the device 10 would enter a power down mode. An advantage of the present system is that if the user 26 needs to use the device 10 when the one battery is depleted, they may simply operate selector switch 16 to power with the device 10 with the other battery, which will be in a fully charged condition.

To recharge the batteries 12, 14, the user 26 would plug in the device 10 to a portable device charging station. A charging circuit in the device 10 may be configured to charge each of the first battery 12 and the second battery 14 simultaneously. The charging circuit may also be configured to determine when one of the first 12 or second batteries 14 are in a fully charged state and direct available charging power to the partially depleted battery to facilitate a quicker recharge of the depleted or partially depleted battery.

It should be understood, of course, that the foregoing relates to exemplary embodiments of the invention and that modifications may be made without departing from the spirit and scope of the invention as set forth in the following claims.

1. A battery system for a portable electronic device, comprising:
a portable electronic device having a housing and interior cavity to contain electronic circuitry for the portable electronic device;
a first battery and a second battery contained within the housing to power the electronic circuitry; and
a battery selector switch, operable from the exterior of the housing, the battery selector switch selectable between a first position and a second position, such that when in the first position, the first battery powers the electronic circuitry, and when in the second position, the second battery powers the electronic circuitry.

2. The battery system for a portable electronic device of claim 1, wherein:
in the first position, the second battery does not power the electronic circuitry; and
in the second position, the first battery does not power the electronic circuitry.

3. The battery system for a portable electronic device of claim 1, further comprising:
indicia proximal to the selector switch indicating a selection of one of the first battery or the second battery.

4. The battery system for a portable electronic device of claim 1. further comprising:
an electronic display visible on at least one surface of the portable electronic device;
a charge state circuit to determine a charge state of the first battery and the second battery; and
a first visual indicator indicating a charge state of the first battery.

5. The battery system for a portable electronic device of claim 4, further comprising:
a second visual indicator indicating a charge state of the second battery.

6. The battery system for a portable electronic device of claim 5, wherein at least one of the first visual indicator and the second visual indicator are shown on the electronic display.

7. The battery system for a portable electronic device of claim 6, wherein the first visual indicator and the second visual indicator comprise:
a graphical indication of the charge state; and
a textual representation of the charge state.

8. The battery system for a portable electronic device of claim 7, further comprising:
a battery selection indicator displayed proximal to one of the first visual indicator and the second visual indicator that provides a visual indication of the battery selected by the battery selector switch.

9. The battery system for a portable electronic device of claim 7, wherein the charge state circuitry powers down the portable electronic device when the charge state circuitry detects a near depleted condition of the selected battery.

10. The battery system for a portable electronic device of claim 7, wherein at least one of the first battery and the second battery is a rechargeable battery.

11. The battery system for a portable electronic device of claim 7, further comprising:
a charging circuit configured to charge the rechargeable battery.

12. The battery system for a portable electronic device of claim 7, wherein the charging circuit is coupled to the charge state circuit and is configured to charge at least one of a depleted or partially depleted rechargeable battery.

13. A battery system for a portable electronic device, comprising:
a portable electronic device having a housing and interior cavity to contain electronic circuitry for the portable electronic device;
a first battery and a second battery contained within the housing to power the electronic circuitry; and
a battery selector switch, operable from the exterior of the housing when the portable electronic device is in either a powered operational state and an unpowered non-operational state, the battery selector switch selectable between a first position and a second position, such that when in the first position, the first battery powers the electronic circuitry, and when in the second position, the second battery powers the electronic circuitry.
